(19) United States
(12) Patent Application Publication
(10) Pub. No.: US 2015/0058219 A1
(43) Pub. Date: Feb. 26, 2015

(54) SYSTEM AND METHOD FOR WORKFLOW BEHAVIOR ALERTS

(71) Applicant: BANK OF AMERICA CORPORATION, Charlotte, NC (US)

(72) Inventors: Glenn M. Grossman, Matthews, NC (US); Kevin Blanchard Perry, Charlotte, NC (US); Aaron R. Leinker, Charlotte, NC (US); Katherine Dintenfass, Charlotte, NC (US); Elizabeth S. Votaw, Potomac, MD (US)

(73) Assignee: BANK OF AMERICA CORPORATION, Charlotte, NC (US)

(21) Appl. No.: 13/975,587

(22) Filed: Aug. 26, 2013

(51) Int. Cl. G06Q 20/40

(52) U.S. Cl. CPC G06Q 20/407
USPC 705/44

(57) ABSTRACT

Embodiments of the invention are directed to systems, methods and computer program products for providing workflow behavior alerts. An exemplary apparatus is configured to monitor characteristics associated with user accounts, identify characteristics for further analysis that affect a value of the user accounts, detect an occurrence of a triggering event based at least partially on the analysis of the characteristics, where the triggering event is defined by one or more rules, initiate a first action in response to detecting the occurrence of the triggering event, wherein the first action comprises sending the user a notification that indicates the occurrence of the triggering event or processing at least one transaction associated with a user account, receive a request to reverse the at least one transaction processed, and reverse the at least one transaction processed in response to receiving the request.

### BACKGROUND

Traditionally, financial institution customers are tasked with having to manually monitor their accounts to manage their funds and investments. For instance, if a customer is aware that the annual yield associated with a particular account is decreasing then they may opt to move their money elsewhere. This can be a burden, as some people may not have the free time to consistently monitor the trends associated with investment products, such as rising and falling stock prices, that directly affect their capital. Therefore, there is a need for a system that offers optimal financial managements by providing alerts and acting on behalf of the customer in instances where special events have occurred.

### BRIEF SUMMARY

Embodiments of the invention are directed to systems, methods, and computer program products for a system for providing workflow behavior alerts. An exemplary system comprises a memory device with computer-readable program code stored thereon, a communication device, and a processing device operatively coupled to the memory device and the communication device. The processing device is configured to execute the computer-readable program code to monitor characteristics associated with user accounts, identify one or more characteristics for further analysis, where the one or more characteristics for further analysis affect a value of the user accounts, detect an occurrence of a triggering event based at least partially on the further analysis of one or more characteristics, where the triggering event is defined by one or more rules, initiate a first action in response to detecting the occurrence of the triggering event, where the first action comprise sending the user a notification that indicates the occurrence of the triggering event or processing at least one transaction associated with a user account, receive a request to reverse the at least one transaction processed, and reverse the at least one transaction processed in response to receiving the request.

In some embodiments the system is further configured to identify the at least one characteristic based at least partially on determining the characteristic has not been altered within a predetermined time period.

In some embodiments, the system is further configured to identify the at least one characteristic based at least partially on determining the characteristic has been altered within a predetermined time period.

In some embodiments, the system is further configured to identify an initial value associated with the at least one characteristic, where the initial sample value is identified at the beginning of a predetermined time period, identify one or more additional sample values associated with the at least one characteristic, where the additional sample values are identified after the beginning of the predetermined time period, and determine based at least partially on a comparison of the sample values whether or not the characteristic has been altered.

In some embodiments, the system is further configured to establish the one or more rules for defining triggering events, determine one or more trends associated with the at least one altered characteristic, and determine the triggering event has occurred based at least partially on analyzing the one or more trends with respect to the one or more rules for defining triggering events.

In some embodiment, the system is further configured to provide the user an offer to process a transaction in response to sending the notification, receive the users acceptance of the offer to process the transaction, and process the transaction in response to receiving the users acceptance of the offer.

In some embodiments, the system is further configured to receive authorization to automatically process the at least one transaction on behalf of the user.

In some embodiments, the system is further configured to notify the user of the at least one transaction processed on behalf of the user.

In some embodiments, the system is further configured to initiate processing the at least one transaction on behalf of the user, request a confirmation to process the transaction on behalf of the user, receive the confirmation to process the transaction on behalf of the user; and, process the transaction on behalf of the user in response to receiving the confirmation.

In some embodiments, the system is further configure to provide the user an option to edit one or more transaction details associated with the confirmation, receive the one or more edited transaction details, and process the transaction on behalf of the user based at least partially on the one or more edited transaction details.

In some embodiments, the system is further configured to initiate one or more secondary actions in response to detecting the occurrence of the triggering event.

In some embodiments, the system is further configured to confirm the account has been restored to its initial state prior to the at least one transaction being processed.

In some embodiments, the system is further configured to present a graphical representation that illustrates a trend associated with the at least one characteristic.

In some embodiments, the system is further configured to receive a predetermined threshold amount, wherein the predetermined threshold amount is associated with the one or more rules for defining triggering events.

In some embodiments, the triggering event is not related to the user account data.

An exemplary method comprises monitoring characteristics associated with user accounts, identifying one or more characteristics for further analysis, where the one or more characteristics for further analysis affect a value of the user accounts, detecting an occurrence of a triggering event based at least partially on the further analysis of one or more characteristics, where the triggering event is defined by one or more rules, initiating a first action in response to detecting the occurrence of the triggering event, where the first action comprise sending the user a notification that indicates the occurrence of the triggering event or processing at least one transaction associated with a user account, receiving a request to reverse the at least one transaction processed, and reversing the at least one transaction processed in response to receiving the request.

In some embodiments, the method further comprises providing the user an offer to process a transaction in response to sending the notification, receiving the users acceptance of the offer to process the transaction, and processing the transaction in response to receiving the users acceptance of the offer.

In some embodiments, the method further comprises initiating processing the at least one transaction on behalf of the user, requesting a confirmation to process the transaction on behalf of the user, receiving the confirmation to process the transaction on behalf of the user, and processing the transaction on behalf of the user in response to receiving the confirmation.

An exemplary computer program product for providing workflow behavior alerts comprises at least one non-transitory computer-readable medium having computer-readable program code portions embodied therein, the computer-readable program code portions comprising an executable portion configured for monitoring characteristics associated with user accounts, an executable portion configured for identifying one or more characteristics for further analysis, where the one or more characteristics for further analysis affect a value of the user accounts, an executable portion configured for detecting an occurrence of a triggering event based at least partially on the further analysis of one or more characteristics, where the triggering event is defined by one or more rules, an executable portion configured for initiating a first action in response to detecting the occurrence of the triggering event, where the first action comprise sending the user a notification that indicates the occurrence of the triggering event or processing at least one transaction associated with a user account, an executable portion configured for receiving a request to reverse the at least one transaction processed, and an executable portion configured for reversing the at least one transaction processed in response to receiving the request.

In some embodiments, the computer program product further comprises a set of code for causing a computer to provide the user an offer to process a transaction in response to sending the notification, receive the users acceptance of the offer to process the transaction; and process the transaction in response to receiving the users acceptance of the offer.

In some embodiments, the computer program product further comprises a set of code for causing a computer to initiate processing the at least one transaction on behalf of the user, request a confirmation to process the transaction on behalf of the user, receive the confirmation to process the transaction on behalf of the user, and process the transaction on behalf of the user in response to receiving the confirmation.

### BRIEF DESCRIPTION OF THE DRAWINGS

Having thus described embodiments of the invention in general terms, reference will now be made to the accompanying drawings, where:

FIG. 1A is a flow chart illustrating a general process flow for providing workflow behavior alerts, in accordance with embodiments of the present invention;

FIG. 1B is a flow chart illustrating a general process flow for providing workflow behavior alerts, in accordance with embodiments of the present invention;

FIG. 2 is a flow chart, illustrating a general process flow for receiving account data, in accordance with embodiments of the present invention;

FIG. 3 is a flow chart illustrating a general process flow for determining a characteristic has been altered, in accordance with embodiments of the present invention;

FIG. 4 is a flow chart illustrating a general process flow for detecting the occurrence of a triggering event, in accordance with embodiments of the present invention;

FIG. 5A is a chart illustrating a general process flow for initiating a workflow behavior action, in accordance with embodiments of the present invention;

FIG. 5B is a chart illustrating a general process flow for reversing a workflow behavior action, in accordance with embodiments of the present invention;

FIG. 6 is a diagram illustrating a system environment for providing workflow behavior alerts, in accordance with embodiments of the present invention; and

FIG. 7 is a screenshot illustrating a monitored characteristic, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for providing workflow behavior alerts. The invention enables an a customer to be provided with automatic alerts or the ability of their financial institution to act of their behalf in instances where certain events have occurred with respect to one or more of the customers financial institution accounts.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded).

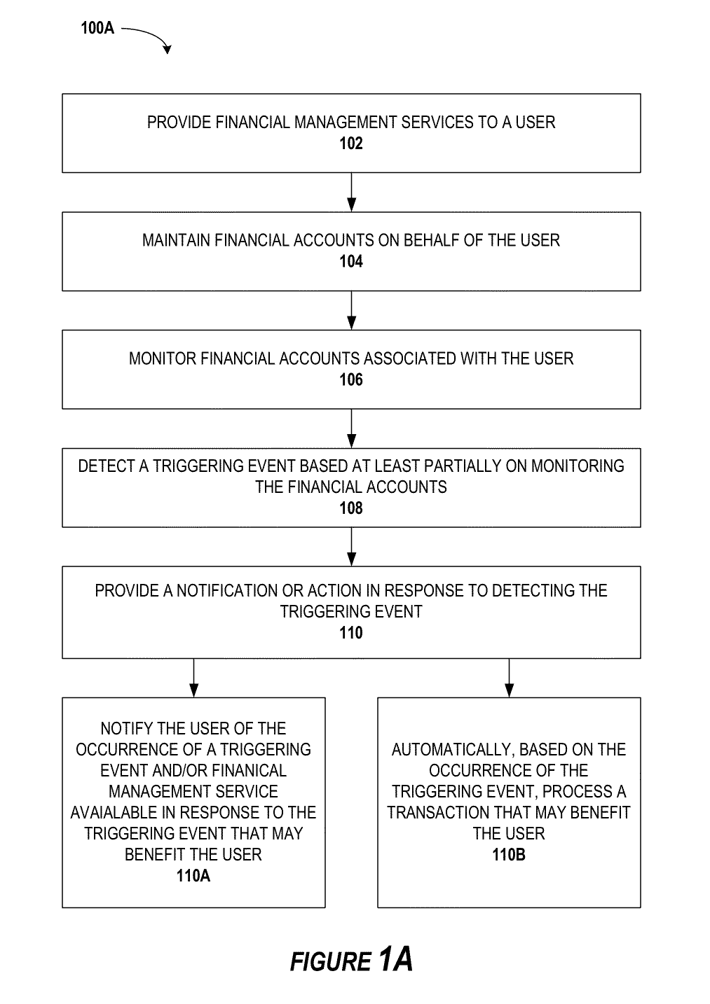

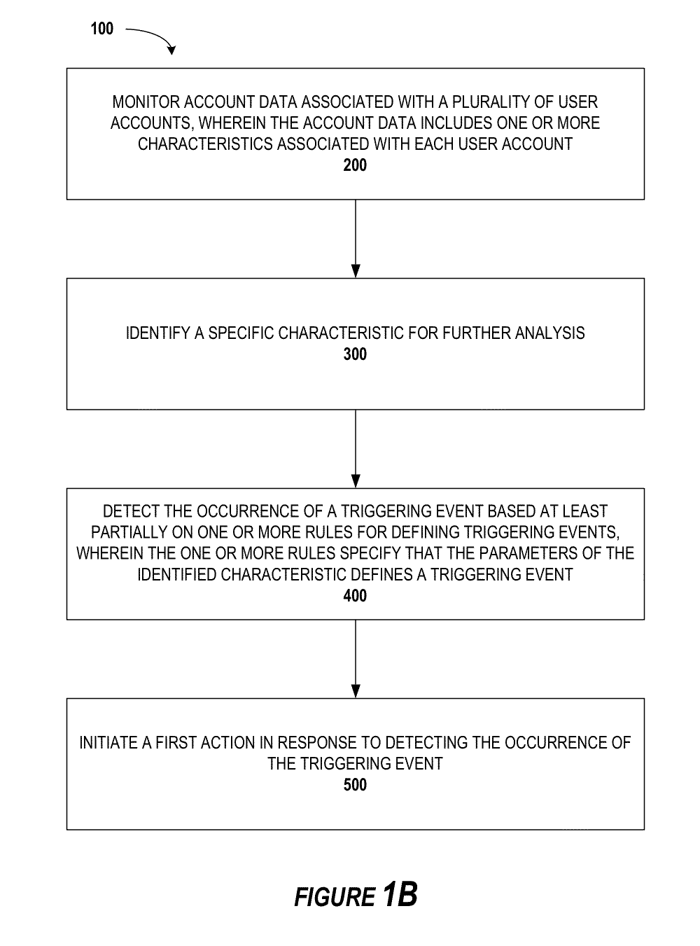

Referring now to FIG. 1A, a general process flow 100A depicts a high-level method for providing a workflow behavior alerts system, according to embodiments of the present invention. As illustrated, the method may comprise initially providing financial management services to a customer 102. The financial institution may be responsible for maintaining financial accounts (e.g. saving account, money market account, or the like) on behalf of the user, at step 104, and providing services that ensure the user is receiving the maximum benefit (e.g. higher interest rates, higher annual yield, or the like) of each account at any given time period without the need of being directly involved with the management of the accounts. The financial management services in some instances require the financial institution to monitor, at step 106, the plurality of financial accounts associated with the user. Monitoring the accounts may occur at a holistic level, or the account may be monitored at a more detailed level where pluralities of individual characteristics (e.g. account balance) of interest are monitored for each account. In monitoring the financial accounts, at step 108, the financial management services may additionally comprise detecting the occurrence of a triggering event. Triggering events may be pre-defined by the user, the financial institution, a third party entity, or a combination of the aforementioned. In an instance that a triggering event is detected, at step 110, the financial management services may additionally include providing either a notification or initiating an action in response to detecting the triggering event.

As illustrated at step 110A, the financial management services may react passively in response to detecting a triggering event by either notifying the user of the occurrence of the triggering event, where the user is made aware of the special event and further determines on their own how they wish to proceed in response, or further offering the user a suggestion by notifying the user of the availability of a financial management service that may benefit the user in some form.

In some embodiments, the alerts may be provided to one or more parties. For example, a user may specify that in addition to being provided with an alert they would like for their spouse or a third party to be provided with the alert. To this extent, the system can push the alert to the user's spouse or financial representative in addition to providing the user with an alert. Providing additional parties with alerts related to the users financial well-being and/or the detection of triggering events may additionally comprise the user specifying one or more permissions for sharing information with third parties, where any party indication as an acceptable entity to share financial information with, may be eligible for receiving user-related alerts. In some instances, alerts may be sent to a group of people such as a financial group associated with the user, a social networking group, a group of peers (e.g. individuals with similar job descriptions) and the like. This information may be sent anonymously such that peers may view triggering events that their counterparts are reacting in response to, and choose to manage their finances in either a similar or alternative manner.

In some embodiments, the system may provide the user with one or more suggestions such that the user may have a number of options to choose from. For example, the system may first notify the user of the occurrence of a triggering event and further suggest options A, B, and C, which may be different financial management services available to the user in response to the occurrence of the triggering event. A user may then select at least one of the options that comprise actions for the system to process on behalf of the user.

In some embodiments, providing the user with an alert or notification may additionally comprise providing detailed information that explains what the triggering event means and how it personally affects the user's finances. In addition to providing the user with different suggestions and options, the system may provide a detailed financial projection associated with each options that illustrates how accepting and/or denying the option will affect the user's financial accounts in the long run. Such a notification may provide the benefits of accepting an option and detail what account parameters would change in response to accepting the option. In some embodiments, the system may additionally graph the financial projection and provide the user with a visual representation of how the triggering event and/or the user of a financial management service will affect their financial account.

In some embodiments, the type of alert that is received may vary based on the type of account the financial institution maintains for the user. For example, if the user is a small business entity, the alerts may be related to small business loan opportunities or cash flow alerts to determine the annual income is enough to cover business expenses. As such, a small business triggering event may be related to detecting that the projected monthly income with not cover the monthly expenses, the system may then alert the small business and provide them with an offer for a small business loan to cover the additional expenses. The user may be provided with the offer based at least partially on the fact that the system has access to the users financial records and can determine that the small business historically timely pays their bills and upholds their financial obligations.

Alternatively, as illustrated at step 110B, the financial management services may react non-passively in response to detecting the occurrence of a triggering event by automatically processing a transaction that may benefit the customer, on the user's behalf. For example, if the triggering event is associated with a rapidly decreasing annual yield of one of the user's accounts, the system may automatically transfer at least a portion of the fund to an account that has a higher interest rate.

Referring now to FIG. 1B, a general process flow 100 depicts a detailed method for providing a workflow behavior alerts system, according to embodiments of the present invention. As illustrated, the method may comprise one or more steps including, but not limited to monitor account data associated with a plurality of user accounts, where the account data includes characteristics of each user account 200, identifying a specific characteristic for further analysis 300, detecting the occurrence of a triggering event according to rules that specify whether or not the parameters of the of the identified characteristic are considered a triggering event 400, and initiating a first action in response to detecting that a triggering event has occurred 500.

At step 200, account data associated with a plurality of user accounts is monitor and in some instances stored in a storage device. A used herein, “account data” includes, but is not limited to any data associated with one or more financial accounts such as transaction amounts, inbound transactions, outbound transactions, transaction channels, transaction categories, transaction dates, identification of third parties to a transaction, payee names, purpose of transactions, transaction transfer data, types of accounts, account balances, and the like. The account data may be received from the user, merchants, other financial institutions such as credit card companies, or any other entity. The account data may additionally include one or more characteristics that further define the user accounts such as interest rates associated with the accounts, and the like.

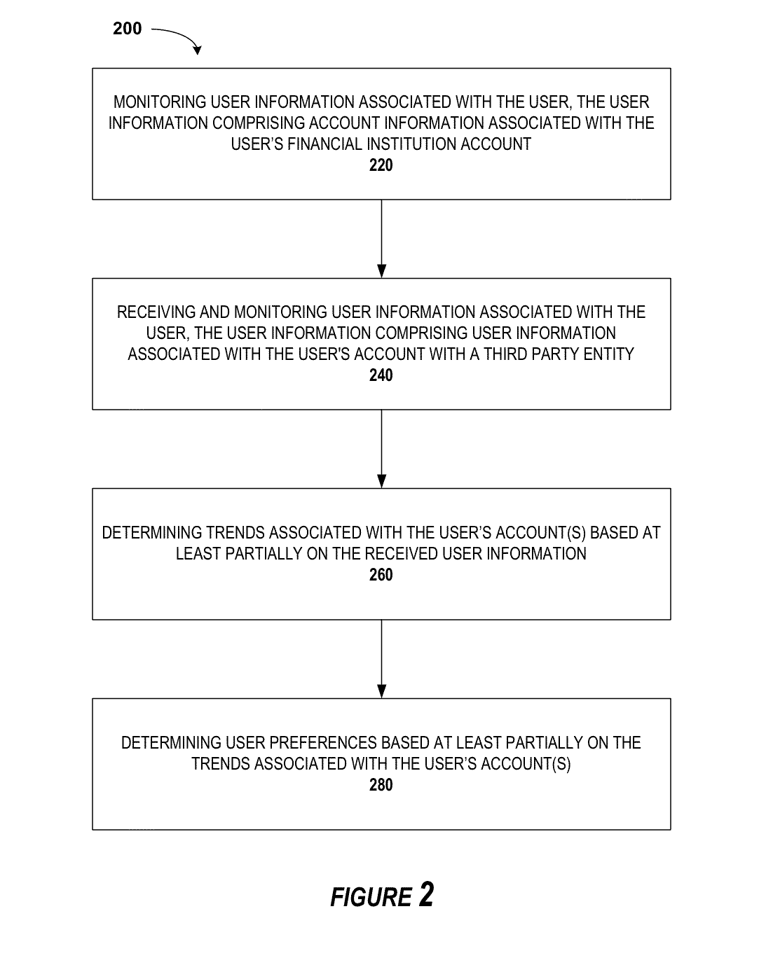

As used herein, account data may also be inclusive of other user information. To this extent monitoring account data may further include monitoring user information. As illustrated in FIG. 2, monitoring user information associated with the user may comprise one or more additional method steps. The additional method steps may include, but not be limited to, monitoring user information associated with the user's financial institution account 220, receiving and monitoring user information associated with the user, the user information comprising user information associated with the user's account with a third party entity 240, determining trends associated with the user's account(s) based at least partially on the received user information 260, and determining user preferences based at least partially on the received user information 280.

The user information may include both account information associated with the user's financial institution account and/or a user account with a third party entity, and personal information associated with the user. In some embodiments, the account information comprises a transaction history associated with the user's financial institution account. The transaction history includes the types of transactions, frequency of transactions, amount of each transaction, merchants associated with transactions, account balance history, etc. Additionally or alternatively, the account information may or may not comprise information associated with incorrect, inconsistent, incomplete, or corrupted transactions.

In some embodiments, the user information may comprise other information as well. For example, in some embodiments, the user information comprises personal information (e.g., demographic information, salary information, contact information (mailing address, email address, phone number, or the like), residence address history, education information, job profile information, etc.) associated with the user. In some embodiments, the personal information further comprises social network information associated with the user's social network account or other non-account related information associated with the user. In some embodiments, the user information further comprises user information (e.g., personal information, account information, etc.) associated with the user's immediate or extended family members or contacts (e.g., as determined from social network information). As such, a service for providing workflow behavior alerts and actions may only be provided to customers that meet specific demographic requirements.

In some instances the system must first gain access to the user's account online prior to receiving the account information. After accessing the user account online the system may extract financial information associated with the user's financial institution account from data displayed through the website and/or from HTML code output by the financial institution's server.

At block 220, user information associated with the user is monitored. In particular the user information received may be associated with the user's financial institution account. In some instances user information may be received and monitored from one or more financial institutions across a plurality of different financial products and/or a third party entity, as illustrated in block 240. For example, in one embodiment, the system monitors information from the user's financial institution about a plurality of different financial products that the user is taking advantage of at that institution. For example, the user may have a checking account, savings account, investment account, mortgage, education loan, car loan, personal loan, credit card account, and/or the like maintained by the financial institution. In some embodiments, the system also receives financial information about the user from one or more other financial institutions with which the user does business. Where a financial institution maintains and/or is affiliated with the financial institution system. In some embodiments, the system may be able to receive a user's financial information from such a financial institution automatically, without user input. However, where a financial institution is not affiliated with a server which houses and stores the user information such as a server associated with a third party entity, the user may need to initially provide the system with account identifying information and one or more pass codes associated with each account.

In one embodiment of the invention, the system monitors, along with financial information received about a user's credit, debit, and loan accounts, information about products that were purchased by the user with money from the user's accounts. In some embodiments, the product information collected by the financial institution is information related to the type of vendor that sold the goods or services to the user. For example, the financial institution may be able to provide a server associated with the financial institution with product information such as the information indicating the merchant associated with a purchased product.

In some instances a server associated with the financial institution may gather and store the user's information such as financial data such that the information is available to the server for later analysis. At block 280, the system may then analyze the user's account information to determine user preferences. For example, in one embodiment, the system determines user preferences based at least partially on determining trends identified in the user's financial, as illustrated by block 260. As such, in one embodiment, the system determines, based at least partially on the user account information associated with the user's financial institution account, which financial transactions and/or financial transaction parameters are regular and which are ad hoc. As used herein, a financial transaction may include any type of financial transaction such as, for example, a product purchase, product return, deposit, withdrawal, cash back transaction, transfer, account inquiry, and/or the like. As used herein, a transaction parameter may be any characteristic of a financial transaction, such as the geographic location of the transaction, the store in which the transaction took place, the company with which the transaction was made, the bank involved in the transaction, the type of financial transaction, the type of financial instrument used in the transaction, the amount of the transaction, a product involved in the transaction, the date of the transaction, the day of the week/month/year of the transaction, the time of day of the transaction, and/or the like. In addition to determining user preferences the system may also receive user preferences that have been explicitly indicated by the user themselves. The system may further comprise a user interface for receiving user preferences from the user.

The account information associated with the user's financial institution account and, in some instances the trends and other user preferences identified therefrom, are used to provide financial data and analysis of said data for use in providing workflow behavior alerts. With the ability of the system to, in some embodiments, accumulate financial data across a number of different financial institutions and identify trends and regular versus ad hoc transactions, the system can, in some embodiments, present the data to in unique ways. In some embodiments, as will be later discussed the system may also determine themes for the workflow behavior alerts, such themes related to the user saving money, projecting the user's cash flow and alerting a user of upcoming financial transactions and hardships, and/or alerting the user of their progress towards a particular financial goal.

In some instances user trends and/or user preferences may be determined at least partially based on supplemental information provided by a particular entity. For example, the user's information associated with a user's financial institution account may be received across a plurality of financial products and/or institutions, the user information may then be aggregated after being received to determine a substantially complete financial picture for the user. In some embodiments, the user's financial information may be supplemented with user-specified financial information since it may not be possible for the financial institution system to access certain accounts or types of financial information, such as information about cash-based transactions.

Aggregated user information such as information associated with the user's financial institution account may be stored in a server associated with the financial institution. The information may then be analyzed to provide useful information about the user to aid in providing workflow behavior alerts. For example, the system computes the user's total net worth and/or provides financial graphs and tools that are customized for the user based on the user's financial information. It should be appreciated that, in some embodiments of the invention, updates may be received regarding information associated with the user's account with one or more financial institutions in real-time or near-real-time. As such, in some such embodiments, the details related to proving workflow behavior alerts are also updated in real-time or near-real-time. For example, user-preferences may, in some embodiments, be updated in real-time or near real-time.

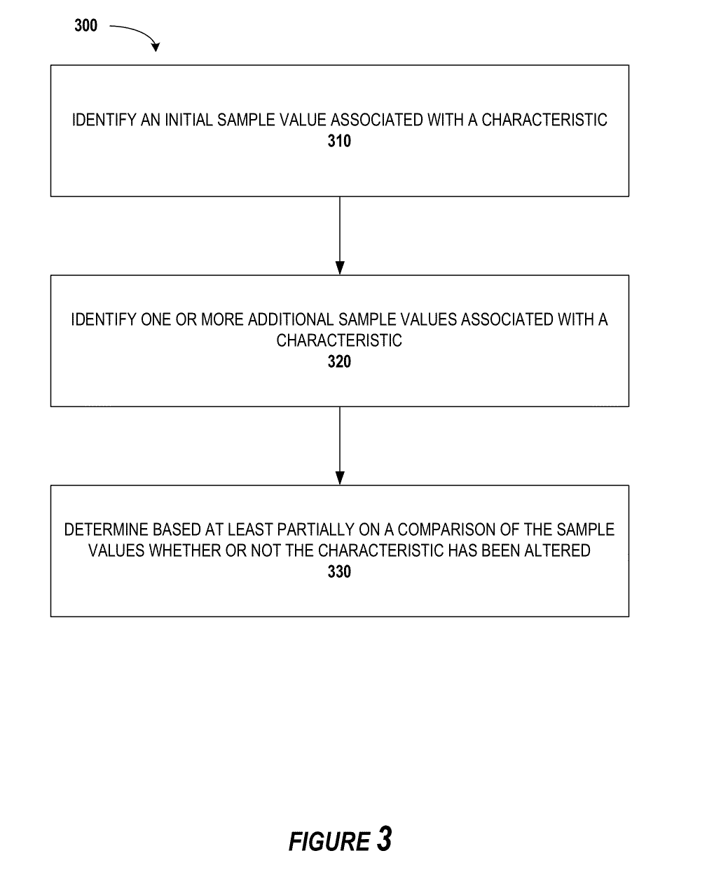

At step 300, the system monitors the account data and identifies at least one characteristic for further analysis. In some embodiments, the characteristic is identified based at least partially on determining that the characteristic has been altered in some way. In other embodiments, the characteristic is identified based at least partially on determining that the characteristic has remained static or unchanged (e.g. not altered) for a predetermined period of time. To this extent, as illustrated in FIG. 3, step 300 may comprise one or more additional method steps. The additional method steps may include, but not be limited to, identifying an initial sample value associated with a characteristic 310, identify one or more additional sample values associated with a characteristic 320, and determine based at least partially on a comparison of the sample values whether or not the characteristic has been altered 330.

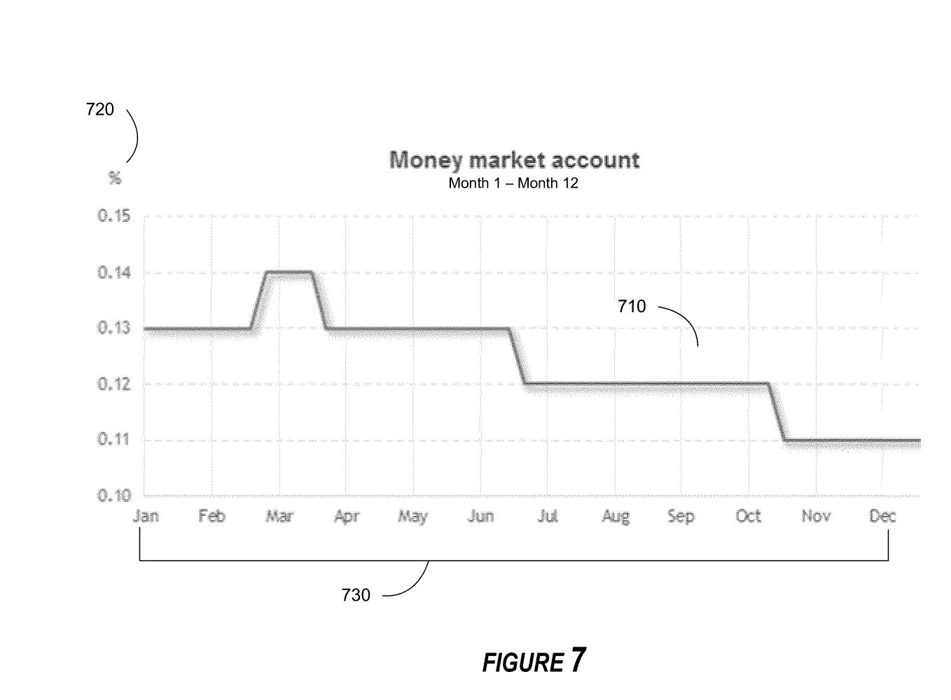

In some embodiments, the system provides a graphical representation that illustrates a trend associated with an account characteristic. For example, if the user has a money market account the monitored characteristic could be the interest rate associated with the money market account. In some embodiments, the characteristic may be analyzed and/or monitored for a predetermined time period or with respect to account data that is related to a specific period of time (e.g. minutes, hours, days, months, years, and the like). As illustrated in FIG. 7, the system may then generate a graph 710 to illustrate any changes in the value of the characteristic 720 over a period of time 730 and present the graph to the user, an entity associated with the financial institution, a third party, and/or the like.

The system may directly analyze the account data or analyze the visual representation to determine the initial and secondary characteristic value and determine that the characteristic has been altered. The initial characteristic sample value may refer to when an account was initially opened, the beginning of a specific quarter or year, or any given point that the system has defined at the starting point of analysis or monitoring. As illustrated in FIG. 3, in one embodiment, the starting point may be January, the system may then determine that the initial sample value of the characteristic (e.g. interest rate) being monitored within the money market account is XX % percent. From then on several additional sample values and subsequent deductions may be determined. A first sample value of XX % percent may be acquired at the end of January. However, at the end of February, the system may determine that based on the second sample value of a specific percentage, the characteristic has been altered over a period of two months and the interest rate has increased a specific percentage. Likewise, in another embodiment, the starting point may be the beginning of the fourth quarter of the fiscal year, the system may then determine that the initial sample value of the characteristic (e.g. interest rate) being monitored within the money market account is a specific percentage. At the end of the fiscal quarter, the system may determine that based on the second sample value of XX % percent, the characteristic has not been altered over a specific month period.

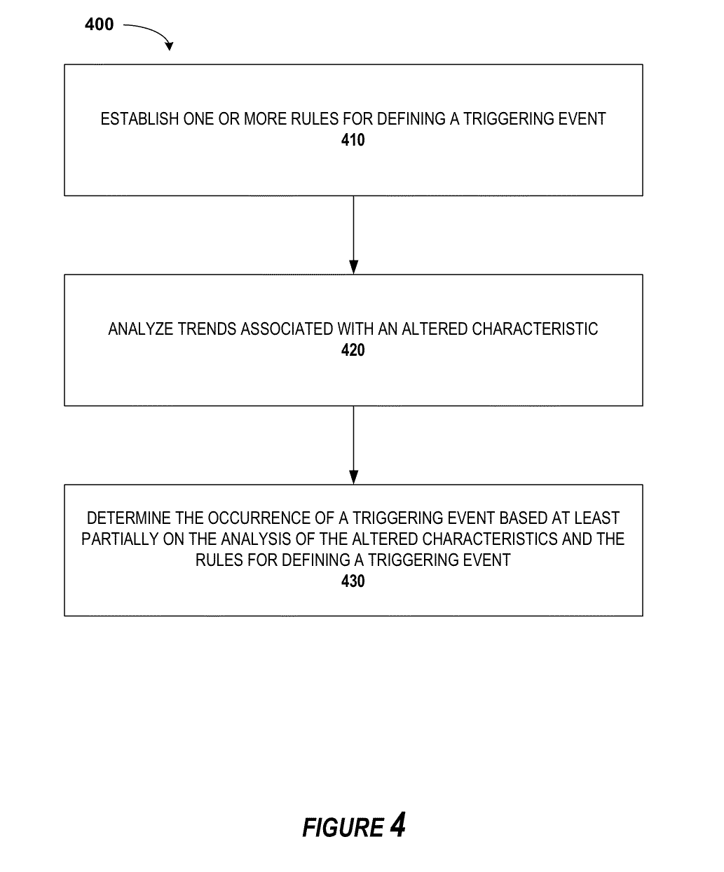

At step 400, the system detects that a triggering event has occurred. Triggering events are detected according to one or more rules for defining triggering events. The rules specify what is considered a triggering event as defined by one or more parties. As illustrated in FIG. 4, step 400 may comprise one or more additional method steps. The additional method steps may include, but not be limited to, establishing one or more rules for defining a triggering event 410, analyzing trends associated with an altered characteristic 420, and determining a triggering event has occurred 430 based at least partially on the analysis of the altered characteristics and the rules for defining a triggering event.

At step 410, rules for defining triggering events may be established and/or determined by the user, the financial institution(s), a third party, or a combination of the aforementioned. For example, a rule may specify that, in one instance, a triggering event is defined by an account interest rate or annual yield percentage associated with an account decreasing more than a predetermined number of units. In some embodiments, the rules may additionally be related to specific parameters associated with the user account. In one embodiment, a user may indicate that triggering events should only be detected for an account(s) which the available balance exceeds a predetermined threshold. For example, the user may indicate that triggering events should only be detected for accounts in which the available balance exceeds X,XXX.XX dollars. A combination of rules may also be used to define a triggering event. For example, a triggering event may be defined by the annual yield percentage associated with an account decreasing more than a predefined percentage, the account having a balance of at least X,XXX.XX dollars, and the account has been open for at least one year. In some embodiment, triggering events may be associated with specific accounts. For instance, any given account may have a circuit breaker that is detected as a triggering event. For example, the circuit breaker may be the interest rate or annual percentage yield falling below a predetermined threshold amount. In this embodiment, the method may further comprise receiving a predetermined threshold amount, wherein the predetermined threshold amount is associated with the one or more rules for defining triggering events.

In some embodiments, the system defines triggering events based on the triggers of other users that have similar demographics. For example, the system may then gather analytics related to a specific subset of people that have demographics similar to the user. The analytics can then be used to determine common triggering events that are being detected within the subset of people, common rules for detecting triggering event as defined by the subset of people, or common events that the subset of people are processing various actions in response to, and use this information to determine typical triggering events to detect for the user. In some embodiments, trends (e.g. trends for defining triggering events) are determined for the subset of people and used to subsequently define one or more triggers that should be detected on the user's behalf.

At step 420, the identified characteristic(s) is analyzed. In some instances trends and/or patterns may be detected during the analysis of a characteristic. Patterns associated with altered and/or identified characteristics are determined based on the account data. The account activity, in some embodiments, is specifically linked to an account type, account details, account available balance, and/or the like. For example, algorithms may be used to detect upward or downward trends in the number of accounts, the available balance of the account, the interest rates associated with the account, or other account activity over a period of time. Available balances for a particular account, for example, may increase during the month of April for several years in a row and provide an indication that the account user has received a bonus that they may be interested in utilizing the funds towards investment or savings purposes. As illustrated in FIG. 7, the system may analyze the interest rate associated with a user's money market account and detect a pattern that indicates from Month 4 to Month 12 the interest rate has been steadily declining.

Parameters associated with the patterns are identified or used as the basis of analysis, where the parameters include accounts types, minimum deposit amounts, available balances, interest rates, annual percentage yield, and the like. The parameters are identified, in some embodiments, by using algorithms, keywords, Boolean, transaction channel codes, transaction amount calculations and threshold amounts to search the account data related to the patterns of account activity. The keywords include identifiers that have been explicitly provided by the user, the financial institution, or a third party entity.

At step 430, the system may determine that a triggering event has occurred. In some embodiments, this determination is at least partially made based on a comparison of parameters of the altered characteristics, such as trends, and the one or more rules for defining triggering events. For example, is the rules define a triggering event as an interest rate declining more the a specific percentage within a given time period, and the system determines that within the last specific time period of months the interest rate associated with a specific account has declined a specific percentage then the system may subsequently determine that a triggering event has occurred. In some embodiments, a triggering event may be defined as when a particular action does not occur. In this instance, the system may determine a triggering event has occurred in response to one or more events not occurring. In some embodiments, a triggering event is detected when the system determines that a loss is going to occur for a specific account. For example, a user may have a plurality of stocks where the purchase price of each stock sets a threshold amount for detecting a triggering event. To this extent, if the price associated with the stock fall below the threshold amount (e.g. purchased price) or is exhibiting a trend that indicates a decline in the prices where the price is nearing the threshold amount, the system may determine that a triggering event, indicating a loss with the stock, has already occurred or is going to occur. The system may additionally analyze the user's personal information, such as tax related disadvantages that the user may encounter in response to a specific available balance associated with an account. The system may then determine that due to the tax related disadvantages the user may eventually incur a loss associated with the account. In other embodiments, a triggering event may be detected in response to detecting the user is approaching the sixth year of a five year adjustable-rate mortgage and determining that as a result the interest rates associated with the mortgage will soon increase substantially and the user may benefit by paying the mortgage off in a quicker manner.

In some embodiments, an analysis is conducted based on potential offers and/or product developments that may be geared towards the user in response to detecting the occurrence of a triggering event within the user's account. For example, the user may be offered a long term certificate of deposit or high-interest savings account in response to detecting the user's funds would be better accrued in a savings account versus being currently placed in a money market account.

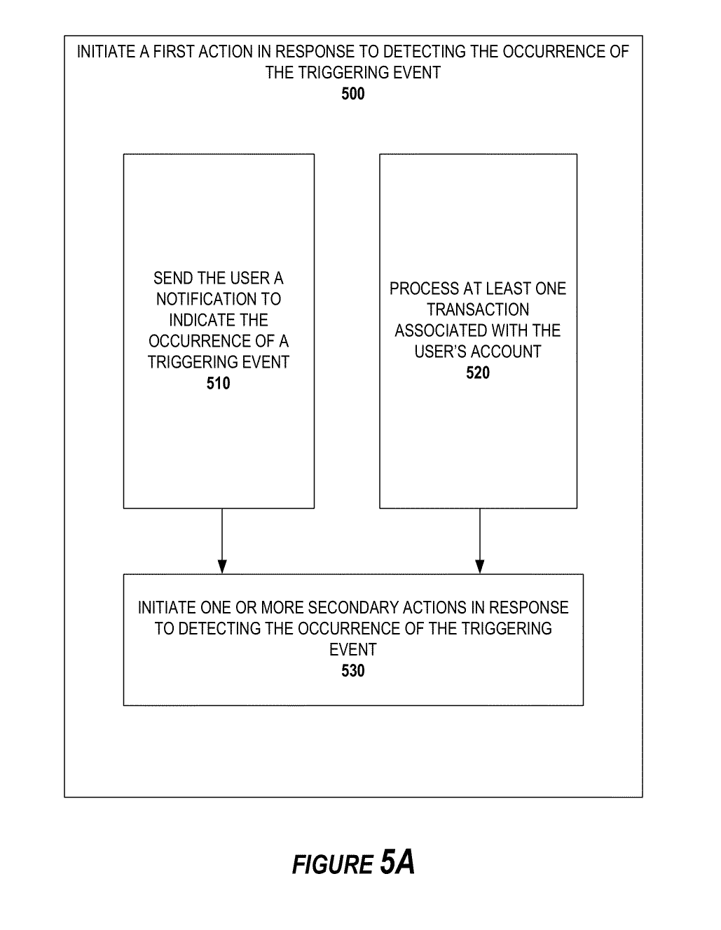

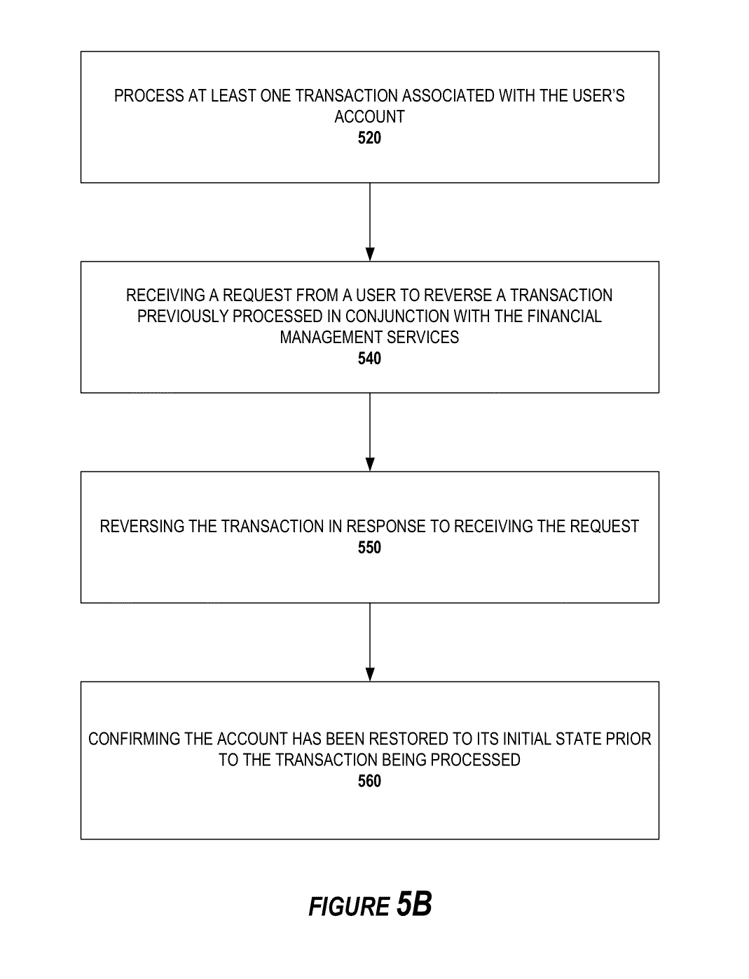

At step 500, in response to detecting the occurrence of a triggering event the system initiates a first action on behalf of the customer. As illustrated in FIG. 5A, step 500 may comprise one or more additional method steps. The additional method steps may include, but not be limited to, sending the user a notification to indicate the occurrence of a triggering event 510, processing at least one transaction associated with the user's account 520, and initiating one or more secondary actions 530. In some embodiments, the system further includes a decision module to aid in determining the action that should be initiated in response to detecting the occurrence of a triggering event.

In one embodiment, the first action may be a passive action such as a user alert. At step 510, the system may send the user an alert associated with the occurrence of a triggering event. In some embodiments, the alerts may contain specific themes with reference to financial management. For example, themes may be related to the user saving an optimal amount of money, or related to helping the user better manage their investment funds to receive a greater yield from a respective account. In some embodiments, the alert themes may be determined by the user, a financial institution or a third party. Additionally, a user may specify in their user preferences the types of alerts or themes they are interested in. In other embodiments, the financial institution may infer the types of alerts the user is interested in based at least partially on the user's account history.

In some embodiments, a triggering event is defined as an event that is not related to the user's account as such the system may alert the user of the triggering event occurring and suggest one or more action to initiate on behalf of the customer. For example, the triggering event may be related to a decrease in bond prices in response to increasing interest rates, as such a savings theme alert may be sent to the user to suggest the user purchase a savings bonds with funds that have been inactive and are associated with an account having a lower interest rate. The user may either accept or decline an offer or suggestion to initiate an action on behalf of the user. In this embodiment, the method may comprise one or more additional steps including, but not limited to, providing the user an offer to process a transaction, receiving the user's acceptance of the offer to process the transaction, and processing the transaction in response to receiving the user's acceptance of the offer.

In another embodiment, the first action may be proactive action such as automatically processing a transaction on behalf of the user. At step 520, the system may process a transaction on behalf of the customer without first notifying and/or alerting the customer to receive approval. However, in this instance, the system may later notify the user that an action was taken on behalf of the customer in response to the occurrence of a triggering event (e.g. a transaction was processed). In some embodiments, the method may further comprise receiving authorization for the user to automatically process transactions on the user's behalf. In some embodiments, authorization may only be granted for a specify type of transactions and/or a specific transaction amount.

In some embodiments, the user is provided with an option to periodically, and/or repeatedly with respect to a predetermined time period, use a financial management service and/or process a given transaction on behalf of the user. For example, a user may choose an option that allows a transaction to be monthly processed on behalf of the user.

In some embodiments, the system may automatically initiate the process for a transaction but require the user to confirm and/or decline the transaction prior to it being processed. For example, in response to determining that the interest rates associated with the user's money market account are steadily declining, the system may automatically initiate the process to transfer at least a portion of the funds in the money market account to a certificate of deposit. The system can then request that the user confirm the transaction prior to transferring the funds. In one embodiment, the user may confirm the transaction and have the funds automatically. In another embodiment, the user may decline to transaction and have the funds remain in the money market account. In yet another embodiment, the user may edit one or more details associated with the transaction confirmation. For example, the financial institution may initiate a process for transferring the funds to a term of years certificate of deposit and the user edit the transaction confirmation details, choose to move the funds to a term of years certificate of deposit instead of a different term of years certificate of deposit, and process the transaction based on the edited information. In some embodiments the option to edit one or more details associated with the transaction is provided in response to the user declining to accept the transaction confirmation.

In an embodiment where the user is not first asked to confirm the transaction prior to it being either automatically processed or processed in response to an alert. The system may additionally be configured to undo any processed transaction associated with the workflow behavior alerts. As such if a user later discovers that a transaction was processed automatically on behalf of the user, but the user did not specifically want to move the funds then the user may request that the transaction be undone. As illustrated in FIG. 5B, in this embodiment, the method may comprise one or more additional steps including but not limited to receiving a request from a user to reverse a transaction previously processed in conjunction with workflow behavior alerts (e.g. financial management services) 540, reversing the transaction in response to receiving the request 550, and confirming the account has been restored to its initial state prior to the transaction being processed 560. For example, the processed transaction associated with the workflow behavior alert may result in transferring funds from the user's checking account to a deposit account. In response to transferring the funds the user may subsequently have another transaction processed that causes the checking account to exceed its available balance. When the user notices that the available balance has been exceeded partially in response to the transaction associated with the workflow behavior alert, the user may request to reverse the transaction. After the transaction has been reversed, the system may also automatically refund the user any service payments associated with the available balance being exceeded to ensure the checking account has been restored to its initial state prior to the transaction being processed.

In some embodiments, the user preferences may specify that actions can only be initiated related to a specific amount of funds associated with an account. The user preferences may specify a predetermined threshold associated with the user account where the system if free to process transactions that that only include funds that exceed the predetermined threshold. For example, if the user has X,XXX.XX hundred dollars in a checking account, the user may specify that any funds that exceed X,XXX.XX dollars may be used in conjunction with workflow behavior alerts. As such, the excess XXX.XX dollars may be transferred to a higher interest savings account. In some embodiment, the user preferences may specify that if the funds have been inactive in an account for a predetermined time period then the funds may be used in conjunction with workflow behavior alerts. In this instance, the user may specify that any funds exceeding X,XXX.XX dollars that have been inactive for at least 1 year may be used in conjunction with workflow behavior alerts. If the excess XXX.XX hundred dollars has been inactive in the checking account for at least 12 months, at 13 months the system may transfer the XXX.XX dollars to a higher interest savings account.

In another example, the user has XX,XXX.XX dollars in a savings account. The user can indicate in their user preferences a safety net amount of XX,XXX.XX dollars, and the excess X,XXX.XX dollars can be used in conjunction with workflow alerts. The safety net amount may indicate the minimum amount of money that the user needs available in emergency situations, thus in some embodiments, the user indicating a safety net amount may further inform the financial institution that the excess X,XXX.XX dollars may be used more liberally such as for the purpose of investments since the user is not necessarily depending on the additional X,XXX.XX dollars in the account. In some embodiments, the user does not have to explicitly indicate a safety net amount. The user may indicate an amount of time for which they would need a safety net. The system may then analyze the user's account data and determine a safety net amount for the predetermined period of time. For example, the user may indicate that they need a specific term of months safety net amount and anything in excess of that amount may be used in conjunction with workflow behavior alerts, the system may then analyze the users account history and determine that their average transactions over a specific month period amounts to XX,XXX.XX dollars. The system would then know that the excess X,XXX.XX dollars may be used for investment purposes.

In some embodiments, the user may further specify in their user preferences that they want to bifurcate a specific amount and/or percentage of funds for use with workflow behavior alerts. For example, if a user has XX,XXX.XX dollars available for use with workflow behavior alerts they may specify that X,XXX.XX dollars should be used towards and investment products and X,XXX.XX dollars should be used towards saving products. Likewise, the user may specify a percentage of the funds for use with bifurcating funds associated with workflow behavior alerts. For example, if the system determines that the user has eight thousand dollars available for use with workflow behavior alerts, the user may specify that XX % percent of the funds should be used towards savings products, a specific percent towards low risk investment products such as low risk mutual funds, and XX % percent towards high risk investment products such as a high risk stock. In some embodiments, a triggering event may be detected in response to the high risk investment product generating a high annual percentage yield than the low risk investment products. In this instance the user may additionally specify that an additional percentage of funds should be transferred from the low risk investment products to the high risk investment products.

At step 530, the system may initiate one or more secondary actions. In some embodiments, a secondary action is initiated in response to detecting the first triggering event. In another embodiment, the secondary action is initiated in response to detecting a second triggering event. For example, the system may detect that a particular stock price is falling (first triggering event). In response to detecting the stock price is falling the system may sell the stocks (first action), and transfer the acquired funds to a certificate of deposit (second action). Likewise, the second action may comprise the system reinvesting the funds.

In some embodiments, a primary and/or secondary action may comprise providing the user with an offer of some sort. As previously mentioned, in some instances, the user is offered a suggestion for processing a beneficial transaction on behalf of the user. However, the system may also provide the user an offer related to a product or service. For example, the system may provide the user with offers related to education opportunities, or personal banking experiences such as a meeting with a financial representative to discuss the users financial well-being related to the triggering events being detected within their account. In some embodiments, the user is recommended an offer based upon their demographic data in addition to the detection a specific triggering event.

In some embodiments, the user may be additionally provided with rewards in response to either agreeing to use the financial management services and/or processing a specific action in response to the detection of a triggering event. For example, if a user agrees to move a specific amount of money into a long term certificate of deposit, the user may receive an additional financial reward, such as protection for exceeding an available balance or an insurance policy, as a result. As such the financial institution may further define what actions and/or amounts qualify for rewards.

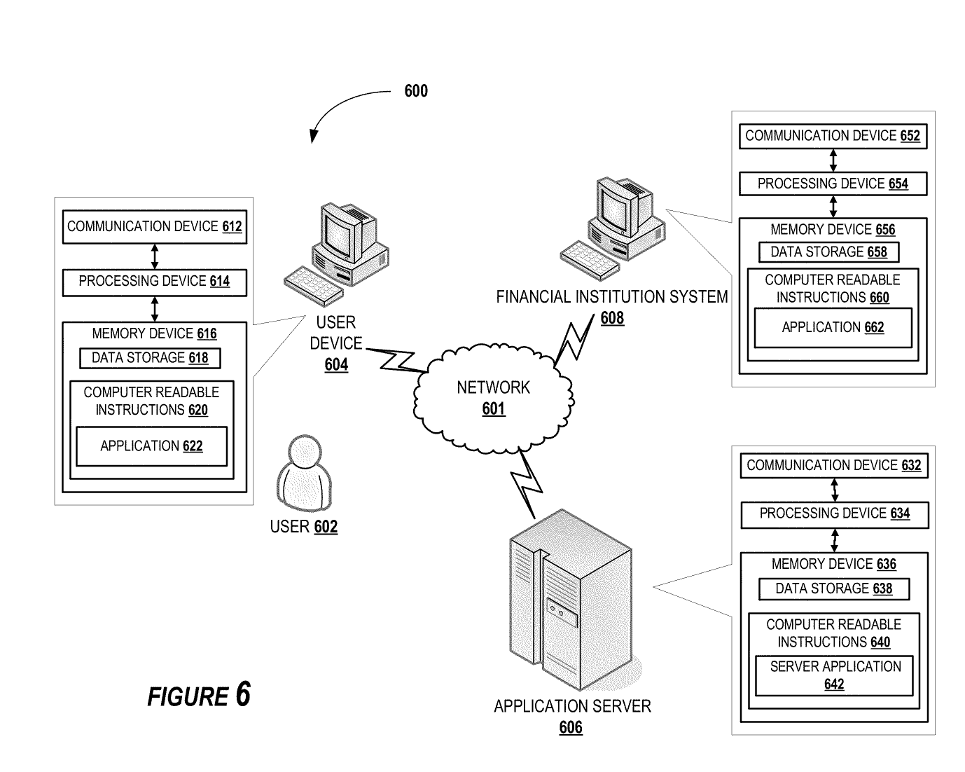

Referring now to FIG. 6, workflow behavior alerts system environment 600, in accordance with one embodiment of the present invention, is illustrated. As shown, the financial institution system 608 is capable of sending and/or receiving information from the application server 606. Likewise, the application server 606 is capable of sending and/or receiving information from the user device 604. This communication may occur across the network 601. The network 601 may be a global area network (GAN), such as the Internet, a wide area network (WAN), a local area network (LAN), or any other type of network or combination of networks. The network 601 may provide for wireline, wireless, or a combination wireline and wireless communication between devices on the network.

The application server 606 may include a processing device 634. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The application server 606 may further include a communication device 632 that is operatively coupled to the processing device 634. The communication device 632 is capable of sending alert information to the user device 604 and/or financial institution system 608 in response to determining that a triggering event associated with at least one user account has occurred. The processing device 634 uses the communication device 632 to communicate with the network 601 and other devices on the network 601, such as, but not limited to, the financial institution system 608 and the mobile device 604. The communication device 632 generally comprises a modem, server, or other device for communicating with other devices on the network 601.

The processing device 634 is also operatively coupled to the memory device 636. The memory device 636 may house computer-readable instructions 640 which may include a server application 642. In some embodiments, the memory device 636 includes data storage 638 for storing data related to the workflow behavior alert system environment 600 including, but not limited to, data used by the server application 642, or information provided by the user 602, user device 604, and/or financial institution system 608. For example, the data storage 638 may store all user information received from the user device 604. The server application 642 may then send the stored user information to the financial institution system 608.

The application server 606 may be operatively coupled over a network 601 to the user device 604, and, in some embodiments, to the financial institution system 608. The financial institution system 608 may include an end system and/or interface used by a business, such as a computer terminal. It should also be noted, in some embodiments the user device 604 may be interchanged with other end consumer systems, such as a mobile device. In this way, the application server 606 can send information to and receive information from the user device 604 and the financial institution system 608 to send alerts and process transactions on behalf of the user 602 based on information provided by various sources discussed herein. FIG. 6 illustrates only one example of an embodiment of workflow behavior alerts system environment 600, and it will be appreciated that in other embodiments one or more of the systems, devices, or servers may be combined into a single system, device, or server, or be made up of multiple systems, devices, or servers.

In the embodiment illustrated in FIG. 6, the server application 642 may enable the user 602 and/or the financial institution to interact with the system. First, the server application 642 enables a user 602 to receive alerts based on his/her user information related to their account with the financial institution, via the user device 604. Next, the server application 642 enables the financial institution to access the user's financial data for use in processing transaction in response to the occurrence of a triggering event. The server application 642 may be capable of sending and/or receiving information to and from the user device 604 and the financial institution system 608. For example, a user device 604 may indicate that the user 602 is interested in processing a particular transaction in response to the system detecting that a triggering event has occurred.

The financial institution system 608 generally includes a communication device 652, a processing device 654, and a memory device 656. The processing device 654 is operatively coupled to communication device 652, and the memory device 656. The financial institution system 608 may include an input device such as a keyboard device to receive information from an individual associated with the financial institution system 608. In some embodiments, the reading device receives information that may be used to communicate instructions via the communication device 652 over a network 601, to other systems such as, but not limited to the application server 606 and/or other systems. The communication device 652 generally comprises a modem, server, or other device for communicating with other devices on the network 601.

The financial institution system 608 includes computer-readable instructions 660 stored in the memory device 656, which in one embodiment includes an application 662. A financial institution system 608 may also refer to any device used to provide information, messages and/or communicate to be sent to a user 602 or the application server 606, including but not limited to, information related to a user 602 receiving workflow behavior alerts. In some embodiments, the financial institution system 608 may refer only to a plurality of components. For example, the financial institution system 608 may refer to a user device, or a user device and a financial institution device interacting with one another to provide workflow behavior alerts. As used herein, the financial institution may also be interchanged with a system associated with a third party entity.

In some embodiments, the financial institution system 608 may serve as an interface between a financial institution and the application server 606 or user device 604 to enable a financial institution to provide workflow behavior alerts. In some embodiments, the financial institution system 608 is or includes an interactive computer terminal that is configured to initiate, communicate, process, and/or facilitate providing workflow behavior alerts for the user 602. A financial institution system 608 could be or include any device that may be used to communicate with a user 602 or the application server 606, such as, but not limited to, a digital sign, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, music-playback device, personal GPS device, or the like), a financial institution terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, the financial institution system 608 may be operated in a public place (e.g., on a street corner, at the doorstep of a private residence, in an open market, at a public rest stop, or the like). In other embodiments, the financial institution system 608 is additionally or alternatively operated in a place of business (e.g., in a retail store, post office, banking center, grocery store, factory floor, or the like). In accordance with some embodiments, the financial institution system 608 may not be operated by the user of the financial institution system 608. In some embodiments, the financial institution system 608 is operated by a mobile business operator or a POS operator (e.g., merchant, vendor, salesperson, or the like). In yet other embodiments, the financial institution system 608 is owned by the entity offering the financial institution system 608 providing functionality in accordance with embodiments of the invention described herein.

FIG. 6 also illustrates a user device 604. The user device 604 may include a communication device 612, a processing device 614, and a memory device 616. The processing device 614 is operatively coupled to the communication device 612 and the memory device 616. The processing device 614 uses the communication device 616 to communicate with the network 601 and other devices on the network 601, such as, but not limited to, the application server 606 and the financial institution system 608. The communication device 616 generally has a modem, server, or other device for communicating with other devices on the network 601.

The user device 604 may have computer-readable instructions 620 stored in the memory device 616, which in one embodiment includes the user application 622. Application 622 may cause the processing device to send and receive information related to the user's 602 workflow behavior alerts. The user device 604 may also include data storage 618 located in the memory device 616. The data storage 618 may be used to store information related to information related to the user's 602 rules for defining triggering events or user preferences for acting in response to the occurrence of a triggering event. A “user device” 204 may or include any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single user device 604 is depicted in FIG. 6, the workflow behavior system 600 may contain numerous mobile devices, similar to user device 604.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for providing workflow behavior alerts, the apparatus comprising:
a memory device with computer-readable program code stored thereon;
a communication device;
a processing device operatively coupled to the memory device and the communication device, wherein the processing device is configured to execute the computer-readable program code to:
monitor characteristics associated with user accounts;
identify one or more characteristics for further analysis, wherein the one or more characteristics for further analysis affect a value of the user accounts;
detect an occurrence of a triggering event based at least partially on the further analysis of one or more characteristics, wherein the triggering event is defined by one or more rules;
initiate a first action in response to detecting the occurrence of the triggering event, wherein the first action comprise sending the user a notification that indicates the occurrence of the triggering event or processing at least one transaction associated with a user account;
receive a request to reverse the at least one transaction processed; and
reverse the at least one transaction processed in response to receiving the request.

2. The system of claim 1, wherein the system is further configured to identify the at least one characteristic based at least partially on determining the characteristic has not been altered within a predetermined time period.

3. The system of claim 1, wherein the system is further configured to identify the at least one characteristic based at least partially on determining the characteristic has been altered within a predetermined time period.

4. The system of claim 3, wherein the system is further configured to:
identify an initial value associated with the at least one characteristic, wherein the initial sample value is identified at the beginning of a predetermined time period;
identify one or more additional sample values associated with the at least one characteristic, wherein the additional sample values are identified after the beginning of the predetermined time period; and
determine based at least partially on a comparison of the sample values whether or not the characteristic has been altered.

5. The system of claim 1, wherein the system is further configured to:
establish the one or more rules for defining triggering events;
determine one or more trends associated with the at least one altered characteristic; and
determine the triggering event has occurred based at least partially on analyzing the one or more trends with respect to the one or more rules for defining triggering events.

6. The apparatus of claim 1, wherein the system is further configured to:
provide the user an offer to process a transaction in response to sending the notification;
receive the users acceptance of the offer to process the transaction; and
process the transaction in response to receiving the users acceptance of the offer.

7. The system of claim 1, wherein the system is further configured to receive authorization to automatically process the at least one transaction on behalf of the user.

8. The system of claim 1, wherein the system is further configured to notify the user of the at least one transaction processed on behalf of the user.

9. The system of claim 1, wherein the system is further configured to:
initiate processing the at least one transaction on behalf of the user;
request a confirmation to process the transaction on behalf of the user;
receive the confirmation to process the transaction on behalf of the user; and
process the transaction on behalf of the user in response to receiving the confirmation.

10. The system of claim 8, wherein the system is further configure to:
provide the user an option to edit one or more transaction details associated with the confirmation;
receive the one or more edited transaction details; and
process the transaction on behalf of the user based at least partially on the one or more edited transaction details.

11. The system of claim 1, wherein the system is further configured to initiate one or more secondary actions in response to detecting the occurrence of the triggering event.

12. The system of claim 1, wherein the system is further configured to confirm the account has been restored to its initial state prior to the at least one transaction being processed.

13. The system of claim 1, wherein the system is further configured to present a graphical representation that illustrates a trend associated with the at least one characteristic.

14. The system of claim 1, wherein the system is further configured to receive a predetermined threshold amount, wherein the predetermined threshold amount is associated with the one or more rules for defining triggering events.

15. The system of claim 1, wherein the triggering event is not related to the user account data.

16. The system of claim 1, wherein at least one characteristic is associated with the user account balance, user account interest rate, or user account percentage of annual yield.

17. The system of claim 1, wherein the one or more rules specify details associated with the parameters of the characteristics that define the triggering event.

18. A computer program product for providing workflow behavior alerts,
the computer program product comprising at least one non-transitory computer-readable medium having computer-readable program code portions embodied therein, the computer-readable program code portions comprising:
an executable portion configured for monitoring characteristics associated with user accounts;
an executable portion configured for identifying one or more characteristics for further analysis, wherein the one or more characteristics for further analysis affect a value of the user accounts;
an executable portion configured for detecting an occurrence of a triggering event based at least partially on the further analysis of one or more characteristics, wherein the triggering event is defined by one or more rules;
an executable portion configured for initiating a first action in response to detecting the occurrence of the triggering event, wherein the first action comprise sending the user a notification that indicates the occurrence of the triggering event or processing at least one transaction associated with a user account;
an executable portion configured for receiving a request to reverse the at least one transaction processed; and
an executable portion configured for reversing the at least one transaction processed in response to receiving the request.

19. The computer program product of claim 16, wherein the computer program product further comprises a set of code for causing a computer to:
provide the user an offer to process a transaction in response to sending the notification;
receive the users acceptance of the offer to process the transaction; and
process the transaction in response to receiving the users acceptance of the offer.

20. The computer program product of claim 16, wherein the computer program product further comprises a set of code for causing a computer to:
initiate processing the at least one transaction on behalf of the user;
request a confirmation to process the transaction on behalf of the user;
receive the confirmation to process the transaction on behalf of the user; and
process the transaction on behalf of the user in response to receiving the confirmation.

21. A method for providing workflow behavior alerts, the method comprising:
monitoring characteristics associated with user accounts;
identifying one or more characteristics for further analysis, wherein the one or more characteristics for further analysis affect a value of the user accounts;
detecting an occurrence of a triggering event based at least partially on the further analysis of one or more characteristics, wherein the triggering event is defined by one or more rules;
initiating a first action in response to detecting the occurrence of the triggering event, wherein the first action comprise sending the user a notification that indicates the occurrence of the triggering event or processing at least one transaction associated with a user account;
receiving a request to reverse the at least one transaction processed; and
reversing the at least one transaction processed in response to receiving the request.

22. The method of claim 22, wherein the method further comprises:
providing the user an offer to process a transaction in response to sending the notification;
receiving the users acceptance of the offer to process the transaction; and
processing the transaction in response to receiving the users acceptance of the offer.

23. The method of claim 21, wherein the method further comprises:
initiating processing the at least one transaction on behalf of the user;
requesting a confirmation to process the transaction on behalf of the user;
receiving the confirmation to process the transaction on behalf of the user; and
processing the transaction on behalf of the user in response to receiving the confirmation.
